(19) United States
(12) Patent Application Publication
(10) Pub. No.: US 2026/0120000 A1
(43) Pub. Date: Apr. 30, 2026

(54) TRAVELING HARDWARE ACCELERATOR FOR DATA SHARING IN COLLABORATIVE LEARNING

(71) Applicant: International Business Machines Corporation, Armonk, NY (US)

(72) Inventors: Shixuan ZHAO, Columbus, OH (US); Zhongshu GU, Ridgewood, NJ (US); Md Salman AHMED, Danbury, CT (US); Enriquillo VALDEZ, Queens, NY (US); Hani Talal JAMJOOM, Cos Cob, CT (US)

(21) Appl. No.: 18/933,171

(22) Filed: Oct. 31, 2024

(51) Int. Cl. G06N 20/20

(52) U.S. Cl. CPC G06N 20/20

(57) ABSTRACT

Embodiments herein describe collaborative learning system that leverage a traveling hardware accelerator. That is, instead of each entity (referred to herein as a “data holder”) having its own hardware accelerator, the data holders share the same hardware accelerator that travels between them. Each data holder can upload its confidential data to the hardware accelerator which is then processed by a shared asset (e.g., a ML model where the confidential data is used as training data, or a statistical parameter model where the confidential data is used to update the statistical parameter or model). Once the confidential data is processed, the data is deleted from the hardware accelerator before the accelerator “travels” and is connected to a different data holder.

### BACKGROUND

The present invention relates to a traveling hardware accelerator for confidential computing.

Federated learning is one solution to enable multiple entities (e.g., different companies or institutions) to collaborate on building machine learning (ML) or artificial intelligence (AI) models without sharing their confidential data sets. For example, the entities may want to train the ML model using all their data but without that data being accessible by the other entities. To do so, a central node can provide an untrained ML model to each of the entities. These entities use their one graphics processing unit (GPU) (or multiple GPUs) to train the ML model using their confidential data. The entities then send the differences between the untrained model they received from the central node and their trained model to the central node. The central node aggregates these differences to generate a ML model that is trained using the confidential data from all the entities. The aggregated model can then be dispatched to all entities for the next training round. Once the pre-determined training criteria (e.g., number of training rounds or the model accuracy) are met, the final trained ML model is distributed to all the entities for their use. Because the entities train their own models, the confidential data never leaves their control, and thus is protected from the other entities. Thus, the entities receive the benefit of having a model trained on a much larger data set, without having to compromise the security of their data.

### SUMMARY

According to one embodiment of the present invention, a method includes providing a shared asset in a hardware accelerator, coupling the hardware accelerator to a first data holder, uploading first confidential data from the first data holder into the hardware accelerator, updating the shared asset using the first confidential data, deleting the first confidential data from the hardware accelerator, coupling the hardware accelerator to a second data holder where the first data holder is no longer able to communicate with the hardware accelerator, uploading second confidential data from the second data holder into the hardware accelerator, and updating the shared asset using the second confidential data.

According to one embodiment of the present invention, a collaborative learning system includes a hardware accelerator comprising a shared asset, a first VM for a first data holder, a second VM for a second data holder, and a third orchestrator VM. The third orchestrator VM is configured to couple the hardware accelerator to the first VM where the first VM is configured to upload first confidential data into the hardware accelerator, update the shared asset using the first confidential data, delete the first confidential data from the hardware accelerator, couple the hardware accelerator to the second VM where the first VM is no longer able to communicate with the hardware accelerator and where the second VM is configured to upload second confidential data into the hardware accelerator, and update the shared asset using the second confidential data.

According to one embodiment of the present invention, a computer program product that includes one or more computer readable storage media and program instructions stored on the one or more storage media to perform operations. The operations include providing a shared asset in a hardware accelerator, coupling the hardware accelerator to a first data holder, uploading first confidential data from the first data holder into the hardware accelerator, updating the shared asset using the first confidential data, deleting the first confidential data from the hardware accelerator, coupling the hardware accelerator to a second data holder where the first data holder is no longer able to communicate with the hardware accelerator, uploading second confidential data from the second data holder into the hardware accelerator, and updating the shared asset using the second confidential data.

### BRIEF DESCRIPTION OF THE DRAWINGS

FIG. 1 illustrates a computing system, according to one embodiment.

FIG. 2A illustrates a collaborative learning system with a traveling hardware accelerator, according to one embodiment.

FIG. 2B illustrates a collaborative learning system with multiple traveling hardware accelerators, according to one embodiment.

FIG. 3 is a flowchart for performing collaborative learning system with a traveling hardware accelerator, according to one embodiment.

FIG. 4 is a flowchart for training a ML model using a traveling GPU, according to one embodiment.

FIGS. 5A-5M illustrate using a traveling GPU to train a ML model, according to embodiments herein.

### DETAILED DESCRIPTION

According to one embodiment of the present invention, a method or computer program product includes providing a shared asset in a hardware accelerator, coupling the hardware accelerator to a first data holder, uploading first confidential data from the first data holder into the hardware accelerator, updating the shared asset using the first confidential data, deleting the first confidential data from the hardware accelerator, coupling the hardware accelerator to a second data holder where the first data holder is no longer able to communicate with the hardware accelerator, uploading second confidential data from the second data holder into the hardware accelerator, and updating the shared asset using the second confidential data. This embodiment has several non-limiting technical advantages such as the data holders can control their confidential data and the shared asset in the hardware accelerator stays in the memory of the hardware accelerator (which can be a confidential computing (CC) accelerator) and may be copied only once from the data holder's VM to the memory of the hardware accelerator. The hardware accelerator travels (or is passed between) the data holders thereby eliminating having to transmit large amounts of data (since ML models can be very large). This improves performance and also reduces the data traffic between the data holder and a central node.

According to one embodiment of the present invention, in the method or computer program product as discussed above, the shared asset is a machine learning (ML) model where updating the shared asset using the first and second confidential data comprises training the ML model using the first and second confidential data and where the hardware accelerator includes one or more graphics processing units (GPUs). Advantageously, the ML model can be trained by each of the data holders without the individual data sets used to train the ML model being available to the other data holders. Also, a traveling GPU can be used to accelerate the training processor.

In the method or computer program product as discussed above, the shared asset is a statistical parameter where updating the shared asset using the first and second confidential data comprises updating a value of the statistical parameter using the first and second confidential data. Advantageously, the statistical parameter can be updated by each of the data holders without the data used to update the statistical parameter being available to the other data holders.

According to any embodiment discussed above, in the method or computer program product, the first and second data holders comprise respective confidential virtual machines (VMs). Advantageously, they improve security to prevent confidential data being exposed to the other data holders.

According to any embodiment discussed above, the method or computer program product includes, before updating the shared asset using the first confidential data, disconnecting, by an orchestrator VM, the first data holder from the hardware accelerator so that the first data holder is no longer able to communicate with the hardware accelerator. Advantageously, they improve security so that first data holder cannot affect the code used to update the shared asset.

According to the previous embodiment, the method or computer program product includes, before updating the shared asset using the first confidential data but after disconnecting the first data holder from the hardware accelerator, uploading, by the orchestrator VM, code into the hardware accelerator, wherein the code updates the shared asset using the first confidential data. Advantageously, this improves security by uploading a fresh copy of the code to ensure that the first data holder did not tamper with the code when it still had access to the hardware accelerator.

According to a previous embodiment, the hardware accelerator is confidential computing (CC) enabled such that keys are used to encrypt data transmitted to the hardware accelerator, the method or computer program product includes, before the second data holder communicates with the hardware accelerator: resetting, by the orchestrator VM, the keys used to communicate with the hardware accelerator; and providing the reset keys to the second data holder but not the first data holder so that the first data holder can no longer communicate with the hardware accelerator. Advantageously, by changing the keys, it prevents the first data holder from accessing the hardware accelerator while it has the confidential data from the second data holder on it.

According to a previous embodiment, the method or computer program product includes using the orchestrator VM to establish a collaborative learning environment to update respective shared assets on one or more respective hardware accelerators for multiple groups of data holders where the orchestrator VM enables each of the respective hardware accelerators to travel to each data holder in a corresponding one of the multiple groups. Advantageously, the embodiments herein can handle multiple collaborative learning environments in parallel.

According to one embodiment of the present invention, a collaborative learning system includes a hardware accelerator comprising a shared asset, a first VM for a first data holder, a second VM for a second data holder, and a third orchestrator VM. The third orchestrator VM is configured to couple the hardware accelerator to the first VM where the first VM is configured to upload first confidential data into the hardware accelerator, update the shared asset using the first confidential data, delete the first confidential data from the hardware accelerator, couple the hardware accelerator to the second VM where the first VM is no longer able to communicate with the hardware accelerator and where the second VM is configured to upload second confidential data into the hardware accelerator, and update the shared asset using the second confidential data. This embodiment has several non-limiting technical advantages such as the data holders can control their confidential data and the shared asset in the hardware accelerator stays in the memory of the hardware accelerator (which can be a confidential computing (CC) accelerator) and may be copied only once from the data holder's VM to the memory of the hardware accelerator. The hardware accelerator travels (or is passed between) the data holders thereby eliminating having to transmit large amounts of data (since ML models can be very large). This improves performance and also reduces the data traffic between the data holder and a central node.

According to one embodiment of the present invention, in the collaborative learning system as discussed above, the shared asset is a machine learning (ML) model where updating the shared asset using the first and second confidential data comprises training the ML model using the first and second confidential data and where the hardware accelerator includes one or more graphics processing units (GPUs). Advantageously, the ML model can be trained by each of the data holders without the individual data sets used to train the ML model being available to the other data holders. Also, a traveling GPU can be used to accelerate the training processor.

In the collaborative learning system as discussed above, the shared asset is a statistical parameter where updating the shared asset using the first and second confidential data comprises updating a value of the statistical parameter using the first and second confidential data. Advantageously, the statistical parameter can be updated by each of the data holders without the data used to update the statistical parameter being available to the other data holders.

According to any embodiment discussed above for the collaborative learning system, the collaborative learning system includes, before updating the shared asset using the first confidential data, disconnecting, by an orchestrator VM, the first data holder from the hardware accelerator so that the first data holder is no longer able to communicate with the hardware accelerator. Advantageously, this improves security so that first data holder cannot affect the code used to update the shared asset.

According to the previous embodiment, the collaborative learning system includes, before updating the shared asset using the first confidential data but after disconnecting the first data holder from the hardware accelerator, uploading, by the orchestrator VM, code into the hardware accelerator, wherein the code updates the shared asset using the first confidential data. Advantageously, this improves security by uploading a fresh copy of the code to ensure that the first data holder did not tamper with the code when it still had access to the hardware accelerator.

According to a previous embodiment of the collaborative learning system, the hardware accelerator is confidential computing (CC) enabled such that keys are used to encrypt data transmitted to the hardware accelerator, the collaborative learning system includes, before the second data holder communicates with the hardware accelerator: resetting, by the orchestrator VM, the keys used to communicate with the hardware accelerator; and providing the reset keys to the second data holder but not the first data holder so that the first data holder can no longer communicate with the hardware accelerator. Advantageously, by changing the keys, it prevents the first data holder from accessing the hardware accelerator while it has the confidential data from the second data holder on it.

According to a previous embodiment, the collaborative learning system includes using the orchestrator VM to establish a collaborative learning environment to update respective shared assets on one or more respective hardware accelerators for multiple groups of data holders where the orchestrator VM enables each of the respective hardware accelerators to travel to each data holder in a corresponding one of the multiple groups. Advantageously, the embodiments herein can handle multiple collaborative learning environments in parallel.

According to one embodiment of the present invention, a hardware accelerator includes circuitry configure to receive first confidential data from a first VM; update the shared asset using the first confidential data; delete the first confidential data from the hardware accelerator; receive, after deleting the first confidential data, second confidential data from a second VM where the first VM is no longer able to communicate with the hardware accelerator; and update the shared asset using the second confidential data. This embodiment has several non-limiting technical advantages such as the data holders can control their confidential data and the shared asset in the hardware accelerator stays in the memory of the hardware accelerator (which can be a confidential computing (CC) accelerator) and may be copied only once from the data holder's VM to the memory of the hardware accelerator. The hardware accelerator travels (or is passed between) the data holders thereby eliminating having to transmit large amounts of data (since ML models can be very large). This improves performance and also reduces the data traffic between the data holder and a central node.

According to the previous embodiment of the hardware accelerator, the shared asset is a ML model where updating the shared asset using the first and second confidential data comprises training the ML model using the first and second confidential data and where the hardware accelerator includes one or more GPUs. Advantageously, the ML model can be trained by each of the data holders without the individual data sets used to train the ML model being available to the other data holders. Also, a traveling GPU can be used to accelerate the training processor.

According to any of previous embodiments of the hardware accelerator, the hardware accelerator is confidential computing (CC) enabled such that keys are used to encrypt data transmitted to the hardware accelerator from the first and second VMs. Advantageously, by using keys, it prevents the first data holder from accessing the hardware accelerator while it has the confidential data from the second data holder on it.

According to one embodiment of the present invention, a computer program product includes one or more computer readable storage media and program instructions stored on the one or more storage media to perform operations. These operations include providing a shared asset in a hardware accelerator; coupling the hardware accelerator to a first data holder such that the first data holder uploads first confidential data into the hardware accelerator and where the hardware accelerator deletes the first confidential data after updating the shared asset using the first confidential data; ensuring the first data holder can no longer communicate with the hardware accelerator; and coupling the hardware accelerator to a second data holder such that the second data holder uploads second confidential data into the hardware accelerator where the hardware accelerator deletes the second confidential data after updating the shared asset using the second confidential data. This embodiment has several non-limiting technical advantages such as the data holders can control their confidential data and the shared asset in the hardware accelerator stays in the memory of the hardware accelerator (which can be a confidential computing (CC) accelerator) and may be copied only once from the data holder's VM to the memory of the hardware accelerator. The hardware accelerator travels (or is passed between) the data holders thereby eliminating having to transmit large amounts of data (since ML models can be very large). This improves performance and also reduces the data traffic between the data holder and a central node.

According to the previous embodiment of the computer program product, the shared asset is a ML model where updating the shared asset using the first and second confidential data comprises training the ML model using the first and second confidential data and where the hardware accelerator includes one or more GPUs. Advantageously, the ML model can be trained by each of the data holders without the individual data sets used to train the ML model being available to the other data holders. Also, a traveling GPU can be used to accelerate the training processor.

Embodiments herein describe a collaborative learning system that leverages a traveling hardware accelerator (e.g., a GPU, field programmable gate array (FPGA), system on a chip (SoC), and the like) to update a shared asset. That is, instead of each entity (referred to herein as a “data holder”) having its own hardware accelerator, the data holders share the same hardware accelerator that travels between them. Traveling does not mean the hardware accelerator moves physically, but rather is communicatively coupled to only one of the data holders at a time to ensure data privacy and security. Each data holder can upload its confidential data to the hardware accelerator which is then processed by the shared asset (e.g., a ML model where the confidential data is used as training data, or a statistical parameter or model where the confidential data is used to update the statistical parameter or model). For example, a traveling hardware accelerator can be used to train a ML model using confidential data from each data holder, where that confidential data is never available to any other data holder, or to update a statistical parameter such as a running average using confidential data from each data holder without the confidential data being shared. Once the confidential data is processed, the data is deleted from the hardware accelerator before the accelerator “travels” and is connected to a different data holder. The resulting ML model or updated statistical parameter could then be distributed to the different data holders for their use.

The embodiments herein have several non-limiting technical advantages such as the data holders can own their own confidential virtual machines (VMs) and control their confidential data. Moreover, the shared asset in the hardware accelerator stays in the memory of the hardware accelerator (which can be a confidential computing (CC) accelerator) and is only copied once from the data holder's VM to the memory of the hardware accelerator. That is, the overhead is lower when compared to federated learning where either the confidential datasets or the model differences have to be transmitted to the central node. In contrast, in the embodiments herein the hardware accelerator travels (or is passed between) the data holders thereby eliminating having to transmit large amounts of data (since ML models can be very large). This improves performance and also reduces the data traffic between the data holder and a central node (which is referred to herein as an orchestrator).

Another non-limiting advantage of a traveling hardware accelerator is that the attack surface may be narrower relative to federated learning. The transmission of the datasets or model difference from data holders to a central node in federated learning involves multiple stages and communication protocols which can broaden the attack surface. In contrast, since the embodiments herein pass the hardware accelerator between the data holders, the actual data and model is never transmitted between data holder VMs. Also, in one embodiment, a different communication key can be used each time when communicating with a data holder VM to the hardware accelerator so that a single point failure cannot compromise other data holders.

The descriptions of the various embodiments of the present invention are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as orchestrator code 200 for operating an orchestrator in a collaborative learning system. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

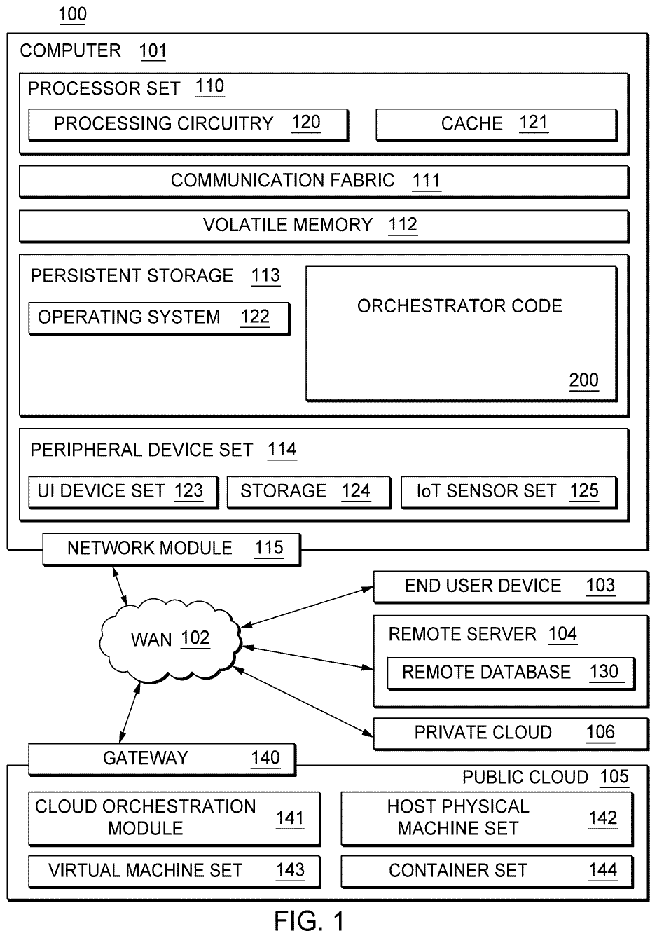

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

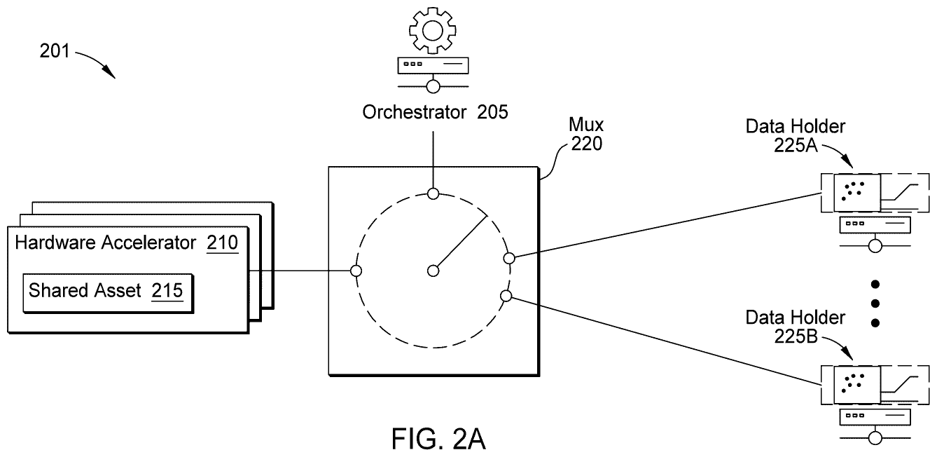

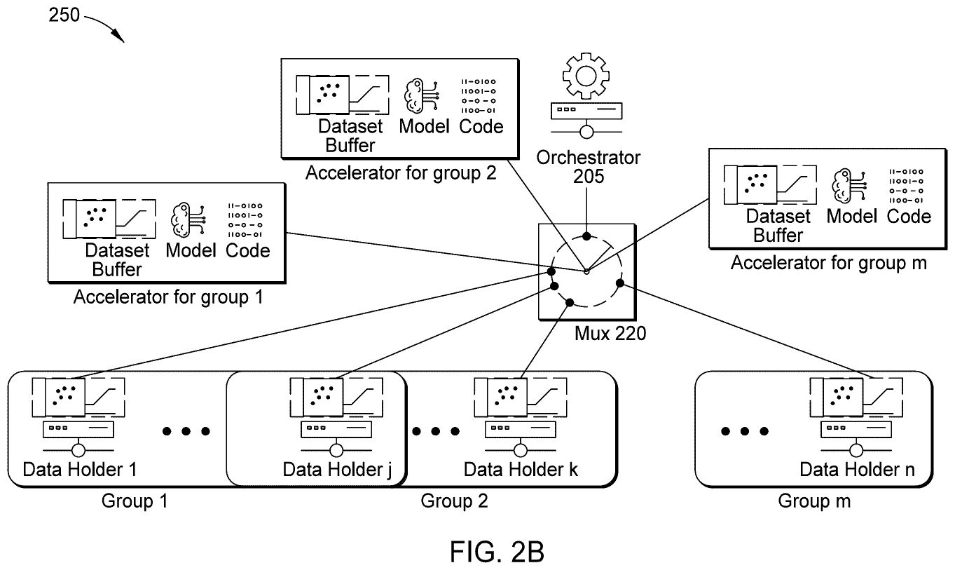

FIG. 2A illustrates a collaborative learning system 201 with a traveling hardware accelerator 210, according to one embodiment. In addition, the system 201 includes a multiplexor (mux) 220 which can be a software or hardware mux that selectively couples an orchestrator 205 and data holders 225 to the hardware accelerator 210. In one embodiment, the orchestrator 205 is a VM that is spun up to control the use of the traveling hardware accelerator 210 by the individual data holders 225. The data holders 225 can also be VMs that are controlled by different entities (e.g., companies or institutions). The orchestrator 205 may be spun up by one of the data holders, but is not necessarily controlled by any one entity (although it could be). In one embodiment, the system 201 is implemented in a data center or a cloud computing environment.

The orchestrator 205 can include the orchestrator code 200 in FIG. 1 for enabling the data holders 225 to access and use a shared asset 215 in the hardware accelerator 210. For example, the shared asset 215 may be a ML model that is trained using confidential datasets stored in the VMs of the data holders 225. Or the shared asset 215 may be a statistical parameter (e.g., an average) or a statistical model that is updated using the confidential datasets stored in the VMs of the data holders 225. Once the shared asset 215 is trained, or updated, using the confidential datasets, the data holders 225 can then enjoy the benefit of using the shared asset 215 to perform other tasks (e.g., perform inference or use the statistical parameter to evaluate other datasets). For example, the data holders 225 may be hospitals that use their confidential datasets to train a ML model to predict an optimal treatment for a new patient, or the data holders 225 can be insurance companies that use their confidential datasets to generate a statistical average that then can be used to predict the likelihood of future events. The embodiments herein are not limited to any particular shared asset 215 for collaborative learning.

Moreover, the hardware accelerator 210 can be any type of accelerator (e.g., a GPU, FPGA, SoC, and the like). In one embodiment, the hardware accelerator 210 is a CC enabled accelerator which provides for secure (e.g., encrypted) communication between the accelerator 210 and the orchestrator 205 and the data holders 225. This means that even the privileged software hosting the VMs (e.g., the hypervisor) cannot snoop on the communications between the accelerator 210 and the VMs.

Further, the collaborative learning system 201 can include multiple traveling hardware accelerators 210. For example, a ML model (e.g., the shared asset 215) may be trained using several GPUs (e.g., multiple hardware accelerators 210). In this case, the GPUs can travel as a bundle where the mux 220 can connect the bundle of GPUs to individual data holders 225 or the orchestrator 205.

FIG. 2B illustrates a collaborative learning system 250 with multiple traveling hardware accelerators assigned to different groups of data holders, according to one embodiment. In this example, the data holders are arranged in different groups for sharing different shared assets. For example, Data Holders 1-J are in Group 1, while Data Holders J and K are in Group 2, and Data Holder n is in Group M. Notably, data holders can be in multiple groups, such as is the case with Data Holder J.

The system 250 also includes at least one accelerator for each group—i.e., Groups 1-M. However, there could be multiple accelerators for each group as shown in FIG. 2A. While each accelerator may be connected to only one of the data holders at any given time, the accelerators in different groups can be coupled to data holders in parallel. That is, the accelerator for Group 1 can communicate with Data Holder 1 at the same time the Accelerator for Group 2 communicates with Data Holder J. Thus, the system 250 can support multiple collaborative learning groups executing at the same time.

In this example, the collaborative learning groups can share the same orchestrator 205. That is, the orchestrator 205 can control collaborative learning for multiple groups. However, in other embodiments, each group may have its own orchestrator 205 (e.g., its own orchestrator VM).

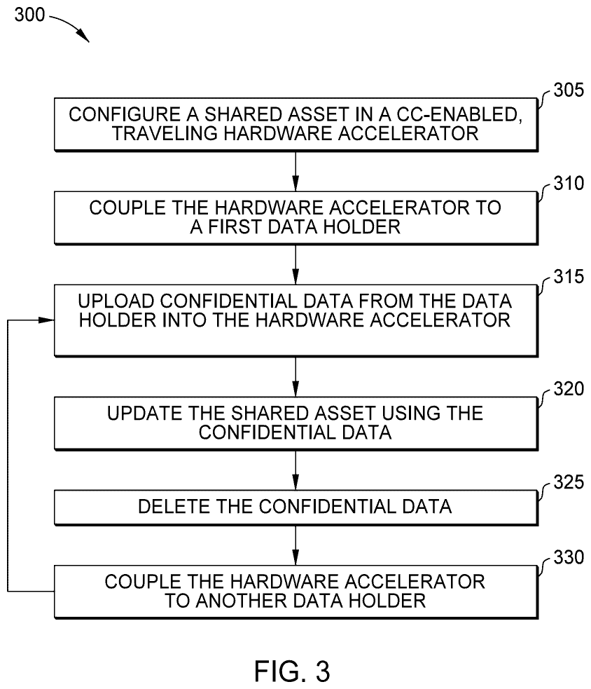

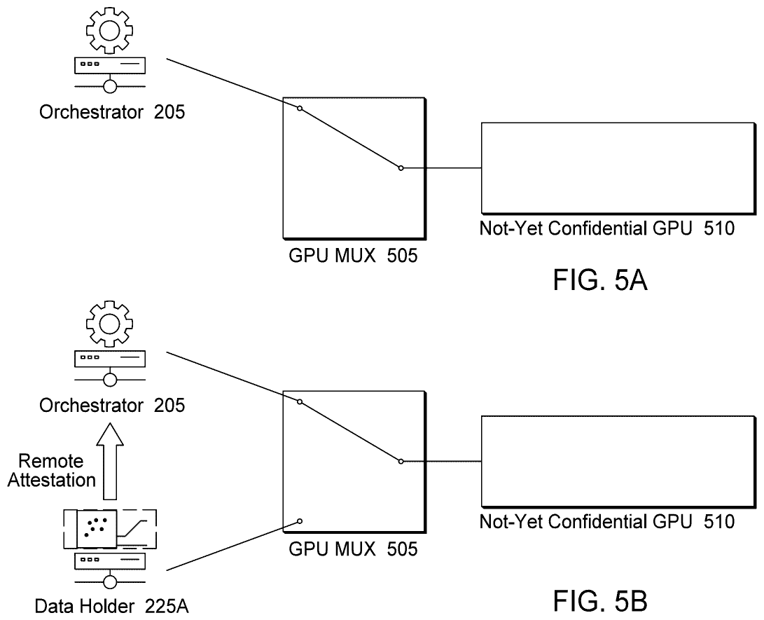

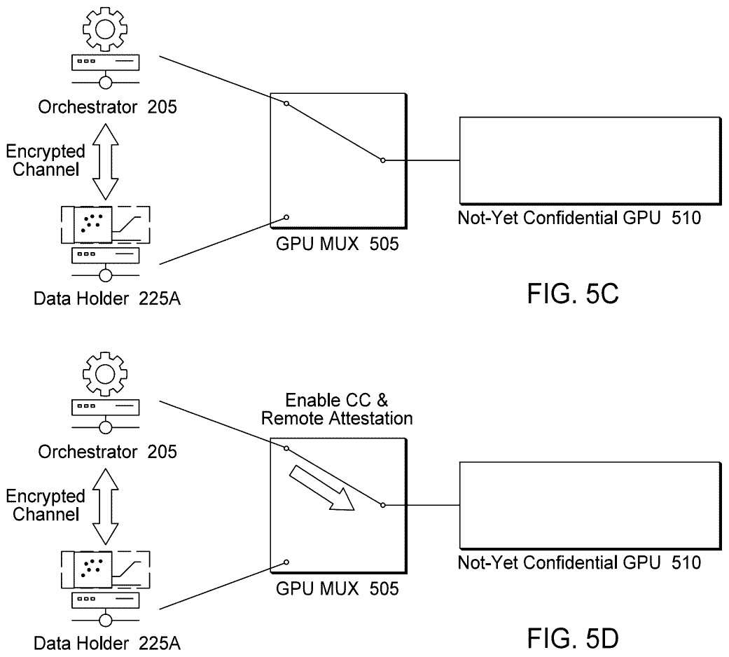

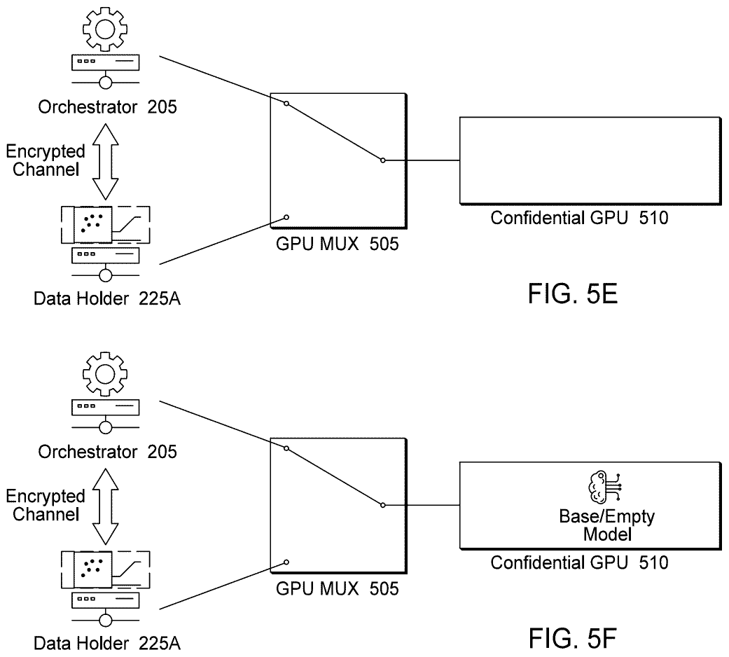

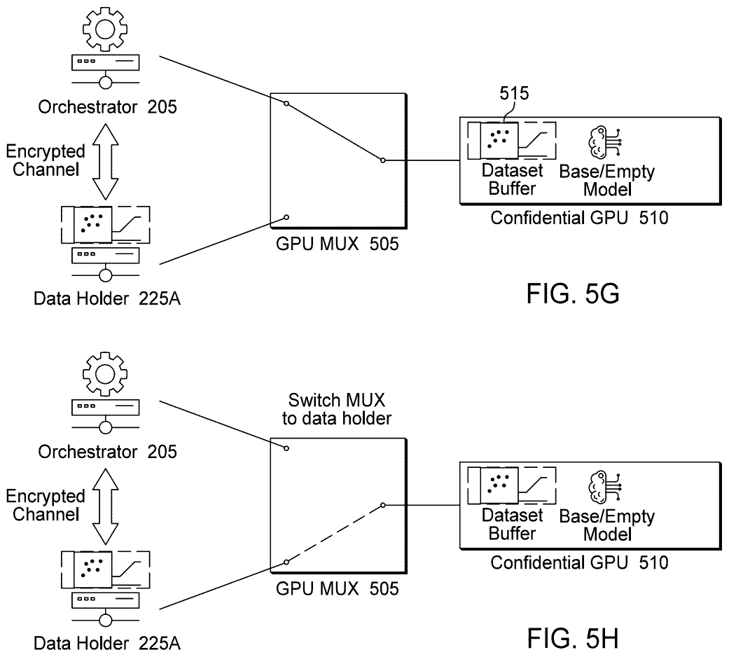

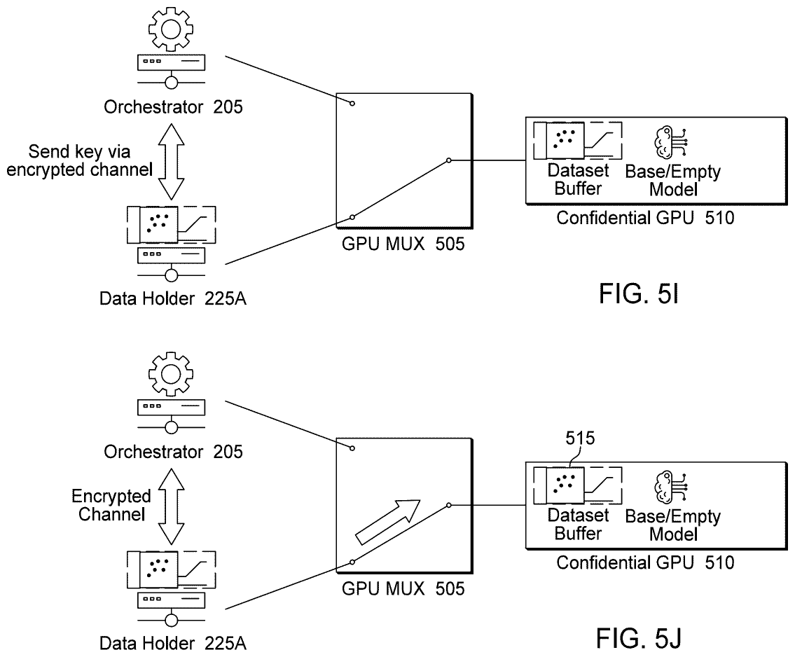

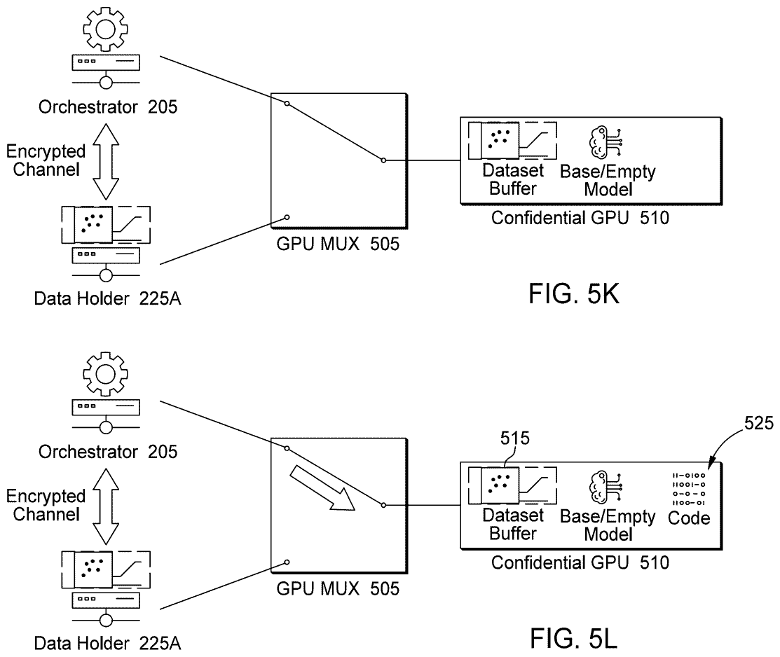

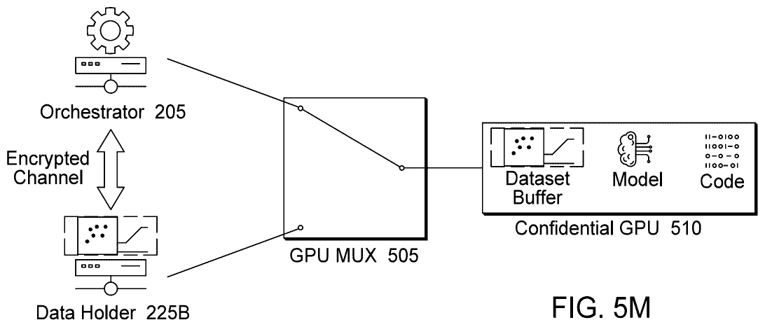

FIG. 3 is a flowchart of a method 300 for performing collaborative learning with a traveling hardware accelerator, according to one embodiment. At block 305, orchestrator code in the orchestrator (e.g., orchestrator 205 in FIG. 2A) configures a shared asset (e.g., shared asset 215) in a CC-enabled, traveling hardware accelerator (e.g., the hardware accelerator 210 in FIG. 2A). Thus, the method 300 assumes that the CPU and hardware accelerator have already been enabled to perform CC, which supports encrypted communication between the orchestrator (and the data holders) and the hardware accelerator. Enabling a hardware accelerator to perform CC will be discussed in more detail in FIGS. 5A-5D below.

However, in other embodiments, the hardware accelerator may not be CC-enabled. Put differently, while using a CC-enabled hardware accelerator may improve data security, it is not necessary since the hardware executing the orchestrator and the data holders may be trusted. Thus, the embodiments herein can be applied to any hardware accelerator that can travel, regardless if that accelerator supports CC.

As mentioned above, the shared asset can be a ML/AI model, a statistical parameter, a statistical model, and the like. In general, the shared asset can be any computing structure that can be updated in a collaborative learning environment by multiple data holders.

At block 310, the orchestrator couples the hardware accelerator to a first data holder using a mux (e.g., mux 220). In one embodiment, the orchestrator ensures the hardware accelerator is communicatively coupled to only one data holder at a time. Moreover, the mux can maintain the connection between the orchestrator and the hardware accelerator in parallel with the connection to a data holder, but this is not necessary.

At block 315, the first data holder uploads confidential data into the hardware accelerator. For example, the hardware accelerator may have a buffer or reserved memory space for storing a confidential dataset from the data holders.

At block 320, the hardware accelerator updates the shared asset using the confidential data. In the case of ML training, the hardware accelerator trains an ML model using the confidential dataset provided by the first data holder. In the case of a statistical parameter or model, the hardware accelerator updates the previous value of the statistical parameter (e.g., a running average) using the confidential dataset provided by the first data holder.

At block 325, the orchestrator instructs the hardware accelerator to delete the confidential data.

At block 330, the orchestrator couples the hardware accelerator to another data holder (e.g., a second data holder) using the mux. Now, the hardware accelerator is no longer coupled to the first data holder, and the confidential dataset for the first data holder has been deleted from the accelerator. As such, the second data holder cannot read the confidential dataset of the first data holder.

The method 300 then returns to block 315 where the second data holder uploads its confidential data to the hardware accelerator. In this manner, blocks 315-330 of the method 300 can repeat until all the data holders in the collaborative learning environment have a chance to update the shared asset in the hardware accelerator using their confidential datasets. Put differently, the hardware accelerator travels between the data holders so that their datasets can be used to update the shared asset.

After cycling through the data holders for, e.g., multiple training rounds, the shared asset can be provided to the data holders which they can use to perform whatever function they want (e.g., perform inference using a trained ML model, perform calculations using a statistical parameter, and the like). In this manner, the individual dataset of the data holders used to generate the shared asset remain confidential while every data holder gets the benefit of using a shared asset that was generated using each of the datasets.

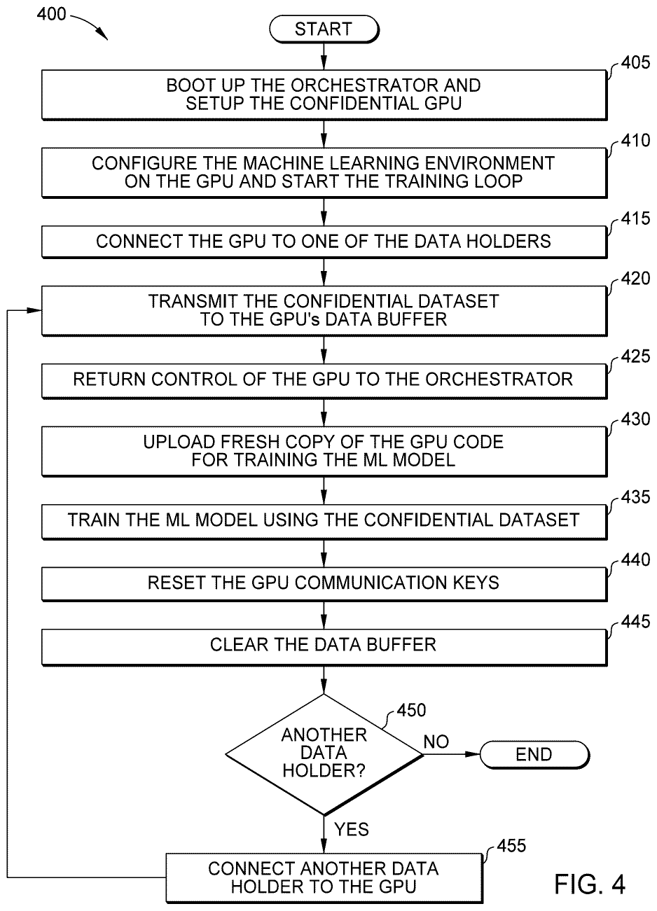

FIG. 4 is a flowchart of a method 400 for training a ML model using a traveling GPU, according to one embodiment. For ease of reference, the blocks in the method 400 are discussed in tandem with FIGS. 5A-5M which illustrate using a traveling GPU to train a ML model, according to embodiments herein. Moreover, FIGS. 4 and 5A-5M are discussed in the context of using a traveling GPU to train a ML model. However, as discussed above, the embodiments herein can apply to other types of shared assets besides training a ML model.

At block 405, the orchestrator boots up once the data holders agree on a type of orchestrator to use. In one embodiment, the orchestrator runs in a confidential VM. Once booted, the orchestrator can set up the confidential GPU. For example, the orchestrator may enable the GPU to support CC, which converts the GPU from a non-confidential GPU to a confidential GPU.

Turning to FIG. 5A, this illustrates a state of a collaborative learning system where the orchestrator 205 is coupled to a GPU 510 using a GPU mux 505. The GPU 510 is one example of the hardware accelerator 210 in FIG. 2A while the GPU mux 505 is one example of the mux 220 in FIG. 2A. In this state, the GPU 510 is not yet confidential. In other words, the GPU 510 is not CC-enabled. As such, the communication between the orchestrator 205 and the GPU 510 may not be encrypted.

FIG. 5B illustrates a state of the collaborative learning system where a data holder 225A uses remote attestation to verify the validity of the orchestrator 205. Before participating in the collaborative learning environment, the data holders 225 (which can be in their own confidential VMs) may use remote attestation to verify the orchestrator 205 was set up properly. For example, a nefarious orchestrator 205 could copy (or steal) the confidential dataset of the other data holders. However, remote attestation ensures that the orchestration code was not manipulated so that the data holder 225A can trust the orchestrator 205.

In one embodiment, remote attestation includes comparing a hash of a VM image used to spin up the orchestrator 205 to a known hash stored in the data holder 225A. If the hashes match, the data holder 225A can validate the orchestrator 205 (i.e., its code was not altered from the version of the orchestrator 205 that was approved by the data holder 225A). However, using hashes is just one example of remote attestation, and the embodiments herein can be used with any suitable type of remote attestation. Moreover, remote attestation is optional since the data holders may already trust the orchestrator 205.

FIG. 5C illustrates a state of the collaborative learning system where a data holder 225A has validated the orchestrator 205 and established an encrypted channel for communicating with the orchestrator 205.

FIG. 5D illustrates a state of the collaborative learning system where the orchestrator 205 enables CC of the GPU 510. Moreover, before doing so, the orchestrator 205 can verify the integrity of the GPU 510 via attestation.

FIG. 5E illustrates a state of the collaborative learning system where CC has been enabled on the GPU 510 which converts it to a confidential GPU 510. In one embodiment, this ensures that encrypted communication is used when transmitting data between the GPU 510 and the orchestrator 205 and the data holders 225.

Returning to method 400, at block 410 the orchestrator configures the ML environment on the confidential GPU and starts the training loop.

FIG. 5F illustrates a state of the collaborative learning system where the orchestrator 205 initializes a base ML model in the confidential GPU 510. For example, the base ML model may be empty, or untrained.

FIG. 5G illustrates a state of the collaborative learning system where the orchestrator 205 allocates a dataset buffer 515 in the confidential GPU 510. This buffer 515 can be reserved by the orchestrator for use by the data holders 225 to store their confidential datasets in the GPU 510.

Returning to method 400, at block 415 the orchestrator connects the GPU to one of the data holders using the GPU mux. In one embodiment, the orchestrator is no longer connected to the GPU when the GPU is connected to the data holder. However, in another embodiment, the orchestrator remains connected to the GPU so it can continue to communicate with the GPU when the GPU also communicates with one of the data holders.

FIG. 5H illustrates a state of the collaborative learning system where the orchestrator 205 switches the mux 505 so that the confidential GPU 510 can communicate with the data holder 225A. However, while there may be a connection between these components, they may be unable to communicate since the GPU 510 (as a CC-enabled device) uses encrypted data communication. The data holder 225A may not have the keys used to decrypt data transmitted by the GPU 510.

FIG. 5I illustrates a state of the collaborative learning system where the orchestrator 205 provides the data encryption key(s) to the data holder 225A. This enables the data holder 225A to send data to, and receive data from, the GPU 510.

While FIGS. 5H and 5I illustrate first coupling the data holder 225A to the GPU 510 and then providing the keys to the data holder 225A, in another embodiment the orchestrator 205 can first send the keys to the data holder 225A and then connect the data holder 225A to the GPU 510 using the mux 505.

Returning to method 400, at block 420 the data holder VM transmits its confidential dataset to the data buffer in the GPU. This is illustrated in FIG. 5J where the data holder 225A copies its dataset into the buffer 520 in the GPU 510.

At block 425, the data holder returns control of the GPU to the orchestrator. That is, the data holder may not actually instruct the GPU to train the ML model using its dataset. This is because the code in the GPU used to train the ML model may have been compromised. Instead, the orchestrator can ensure the proper code is used as explained below. As illustrated in FIG. 5K, the mux 505 enables the communication link between the GPU 510 and the orchestrator 205.

At block 430, the orchestrator uploads a fresh copy of the GPU code for training the ML model. FIG. 5L illustrates a state where the orchestrator 205 has upload the code 525 into the GPU 510. This may be the first time the code 525 has been loaded into the GPU 510, or there could have already been a copy of the code 525 in the GPU 510. In any case, before training the ML model using confidential dataset for the data holders 225, the orchestrator 205 may upload a fresh copy of the code 525 which overwrites whatever code was already stored in the GPU in case the code 525 has been accidentally or maliciously edited.

At block 435, the orchestrator trains the ML model using the confidential dataset. Again referring to FIG. 5L, the orchestrator may execute the code 525 so that the code 525 trains the ML model using the confidential dataset stored in the buffer 515.

At block 440, the orchestrator resets the GPU communication keys. That is, the orchestrator can change the keys used in secure communication with the GPU so that the keys that were provided to the data holder 225A in FIG. 5I no longer work. That way, if the data holder 225A was someway able to maintain its connection to the GPU 510 (e.g., the mux 505 malfunctioned), the data holder 225A would not be able to communicate with the GPU 510 since its encryption keys are no longer valid, and thus would be unable to retrieve confidential data that a different data holder uploaded into the GPU 510.

At block 445, the orchestrator clears the data buffer 515 containing the confidential dataset for the data holder.

At block 450, the orchestrator determines whether another data holder should have a turn training the ML model. If so, the method proceeds to block 455 where the orchestrator connects another data holder to the GPU. This can include the same process described in block 415 of the method 400 and in FIGS. 5H and 5I. FIG. 5M illustrates the orchestrator 205 communicating with a second data holder 225B in order to connect it to the confidential GPU 510. In this manner, the method 400 can repeat for each data holder.

However, if the ML model has been trained using the confidential datasets from each data holder, the method 400 can end. The orchestrator VM can then transmit the trained ML model to the data holders, or the GPU can again travel so the data holders can use the trained ML model to perform inference.

While the foregoing is directed to embodiments of the present invention, other and further embodiments of the invention may be devised without departing from the basic scope thereof, and the scope thereof is determined by the claims that follow.

What is claimed is:

1. A method comprising:
providing a shared asset in a hardware accelerator;
coupling the hardware accelerator to a first data holder;
uploading first confidential data from the first data holder into the hardware accelerator;
updating the shared asset using the first confidential data;
deleting the first confidential data from the hardware accelerator;
coupling the hardware accelerator to a second data holder, wherein the first data holder is no longer able to communicate with the hardware accelerator;
uploading second confidential data from the second data holder into the hardware accelerator; and
updating the shared asset using the second confidential data.

2. The method of claim 1, wherein the shared asset is a machine learning (ML) model, wherein updating the shared asset using the first and second confidential data comprises training the ML model using the first and second confidential data, wherein the hardware accelerator includes one or more graphics processing units (GPUs).

3. The method of claim 1, wherein the shared asset is a statistical parameter, wherein updating the shared asset using the first and second confidential data comprises updating a value of the statistical parameter using the first and second confidential data.

4. The method of claim 1, wherein the first and second data holders comprise respective confidential virtual machines (VMs).

5. The method of claim 1, further comprising, before updating the shared asset using the first confidential data:
disconnecting, by an orchestrator VM, the first data holder from the hardware accelerator so that the first data holder is no longer able to communicate with the hardware accelerator.

6. The method of claim 5, further comprising, before updating the shared asset using the first confidential data but after disconnecting the first data holder from the hardware accelerator:
uploading, by the orchestrator VM, code into the hardware accelerator, wherein the code updates the shared asset using the first confidential data.

7. The method of claim 5, wherein the hardware accelerator is confidential computing (CC) enabled such that keys are used to encrypt data transmitted to the hardware accelerator, the method further comprising, before the second data holder communicates with the hardware accelerator:
resetting, by the orchestrator VM, the keys used to communicate with the hardware accelerator; and
providing the reset keys to the second data holder but not the first data holder so that the first data holder can no longer communicate with the hardware accelerator.

8. The method of claim 5, further comprising:
using the orchestrator VM to establish a collaborative learning environment to update respective shared assets on one or more respective hardware accelerators for multiple groups of data holders, wherein the orchestrator VM enables each of the respective hardware accelerators to travel to each data holder in a corresponding one of the multiple groups.

9. A collaborative learning system, comprising:
a hardware accelerator comprising a shared asset;
a first VM for a first data holder;
a second VM for a second data holder; and
a third orchestrator VM configured to:
couple the hardware accelerator to the first VM, wherein the first VM is configured to upload first confidential data into the hardware accelerator;
update the shared asset using the first confidential data;
delete the first confidential data from the hardware accelerator;
couple the hardware accelerator to the second VM, wherein the first VM is no longer able to communicate with the hardware accelerator, and wherein the second VM is configured to upload second confidential data into the hardware accelerator; and
update the shared asset using the second confidential data.

10. The collaborative learning system of claim 9, wherein the shared asset is a machine learning (ML) model, wherein updating the shared asset using the first and second confidential data comprises training the ML model using the first and second confidential data, wherein the hardware accelerator includes one or more graphics processing units (GPUs).

11. The collaborative learning system of claim 9, wherein the shared asset is a statistical parameter, wherein updating the shared asset using the first and second confidential data comprises updating a value of the statistical parameter using the first and second confidential data.

12. The collaborative learning system of claim 9, wherein the third orchestrator VM is configured to, before updating the shared asset using the first confidential data:
disconnect the first data holder from the hardware accelerator so that the first VM is no longer able to communicate with the hardware accelerator.

13. The collaborative learning system of claim 12, wherein the third orchestrator VM is configured to, before updating the shared asset using the first confidential data but after disconnecting the first data holder from the hardware accelerator:
upload code into the hardware accelerator, wherein the code updates the shared asset using the first confidential data.

14. The collaborative learning system of claim 9, wherein the hardware accelerator is confidential computing (CC) enabled such that keys are used to encrypt data transmitted to the hardware accelerator, the orchestrator VM is configured to, before the second data holder communicates with the hardware accelerator:
reset, by the orchestrator VM, the keys used to communicate with the hardware accelerator; and
provide the reset keys to the second VM but not the first VM so that the first data holder can no longer communicate with the hardware accelerator.

15. The collaborative learning system of claim 9, wherein the orchestrator VM is configured to establish a collaborative learning environment to update respective shared assets on one or more respective hardware accelerators for multiple groups of data holders, wherein the orchestrator VM enables each of the respective hardware accelerators to travel to each data holder in a corresponding one of the multiple groups.

16. A computer program product comprising:
one or more computer readable storage media; and
program instructions stored on the one or more storage media to perform operations comprising:
providing a shared asset in a hardware accelerator;
coupling the hardware accelerator to a first data holder;
uploading first confidential data from the first data holder into the hardware accelerator;
updating the shared asset using the first confidential data;
deleting the first confidential data from the hardware accelerator;
coupling the hardware accelerator to a second data holder, wherein the first data holder is no longer able to communicate with the hardware accelerator;
uploading second confidential data from the second data holder into the hardware accelerator; and
updating the shared asset using the second confidential data.

17. The computer program product of claim 16, wherein the shared asset is a machine learning (ML) model, wherein updating the shared asset using the first and second confidential data comprises training the ML model using the first and second confidential data, wherein the hardware accelerator includes one or more graphics processing units (GPUs).

18. The computer program product of claim 16, wherein the shared asset is a statistical parameter, wherein updating the shared asset using the first and second confidential data comprises updating a value of the statistical parameter using the first and second confidential data.

19. The computer program product of claim 16, wherein the operations further comprises, before updating the shared asset using the first confidential data:
disconnecting, by an orchestrator VM, the first data holder from the hardware accelerator so that the first data holder is no longer able to communicate with the hardware accelerator.

20. The computer program product of claim 19, wherein the operations further comprises, before updating the shared asset using the first confidential data but after disconnecting the first data holder from the hardware accelerator:
uploading, by the orchestrator VM, code into the hardware accelerator, wherein the code updates the shared asset using the first confidential data.

21. A hardware accelerator comprising:
circuitry configured to:
receive first confidential data from a first virtual machine (VM);
update a shared asset using the first confidential data;
delete the first confidential data from the hardware accelerator;
receive, after deleting the first confidential data, second confidential data from a second VM, wherein the first VM is no longer able to communicate with the hardware accelerator; and
update the shared asset using the second confidential data.

22. The hardware accelerator of claim 21, wherein the shared asset is a machine learning (ML) model, wherein updating the shared asset using the first and second confidential data comprises training the ML model using the first and second confidential data, wherein the hardware accelerator includes one or more graphics processing units (GPUs).

23. The hardware accelerator of claim 21, wherein the hardware accelerator is confidential computing (CC) enabled such that keys are used to encrypt data transmitted to the hardware accelerator from the first and second VMs.

24. A computer program product comprising:
one or more computer readable storage media; and
program instructions stored on the one or more storage media to perform operations comprising:
providing a shared asset in a hardware accelerator;
coupling the hardware accelerator to a first data holder such that the first data holder uploads first confidential data into the hardware accelerator, wherein the hardware accelerator deletes the first confidential data after updating the shared asset using the first confidential data;
ensuring the first data holder can no longer communicate with the hardware accelerator; and
coupling the hardware accelerator to a second data holder such that the second data holder uploads second confidential data into the hardware accelerator, wherein the hardware accelerator deletes the second confidential data after updating the shared asset using the second confidential data.

25. The computer program product of claim 24, wherein the shared asset is a machine learning (ML) model, wherein updating the shared asset using the first and second confidential data comprises training the ML model using the first and second confidential data, wherein the hardware accelerator includes one or more graphics processing units (GPUs).
